(19) United States
(12) Patent Application Publication
(10) Pub. No.: US 2008/0011657 A1
(43) Pub. Date: Jan. 17, 2008

(54) WATER-CLEANER

(76) Inventor: Chiang-Pei Chen, Taiping City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/456,649

(22) Filed: Jul. 11, 2006

(51) Int. Cl. B01D 35/14

(52) U.S. Cl. 210/130; 210/426; 210/257.1

(57) ABSTRACT

A portable direct current water-cleaner includes a tank for containing water, a pump installed in the tank for pumping the water, a filter installed in the tank for filtering the water and a valve installed in the tank and movable between a first mode for directing the water from the pump to the filter so that the pump makes the water travel through the filter fast and a second position for bypassing the filter.

### BACKGROUND OF INVENTION

1. Field of Invention

The present invention relates to a water-cleaner and, more particularly, to a portable direct current water-cleaner.

2. Related Prior Art

Disclosed in Taiwanese Patent Publication No. 564769 is a portable bottle-type water-filtering apparatus. The apparatus includes a bottle 50, a cap 10 and a filter 20. The bottle 50 is formed with a bottleneck 51. The cap 10 includes a tube 12 and a socket 14. The tube 12 includes a first section extended from a first side of the cap 10 and a second section extended from a second side of the cap 10. The socket 14 is formed on the second side of the cap 10 around the second section of the tube 12. The filter 20 includes a case and a filtering material 21 filled in the case. The case includes a sieve 23 at an end and an opening at an opposite end. A neck 22 is formed on the sieve 23 and fit in the socket 14. A plug 25 is fit in the opening of the case. A plurality of apertures 251 is defined in the plug 25.

The above-mentioned portable bottle-type water-filtering apparatus contains a small amount of water. Therefore, it is not very helpful when it is used during camping in the wilds where water is scarce. A large water-filtering apparatus contains a large amount of water; however, it takes a lot of time for the large water-filtering apparatus to filter water, and this is inconvenient.

The present invention is therefore intended to obviate or at least alleviate the problems encountered in prior art.

### SUMMARY OF INVENTION

According to the present invention, a portable direct current water-cleaner includes a tank for containing water, a pump installed in the tank for pumping the water, a filter installed in the tank for filtering the water and a valve installed in the tank and movable between a first mode for directing the water from the pump to the filter so that the pump makes the water travel through the filter fast and a second position for bypassing the filter.

It is an advantage of the water-cleaner according to the present invention to clean water fast for using the pump to pump the water through the filter.

It is another advantage of the water-cleaner according to the present invention to provide options of whether to clean the water or not.

Other advantages and features of the present invention will become apparent from the following description referring to the drawings.

### BRIEF DESCRIPTION OF DRAWINGS

The present invention will be described through detailed illustration of three embodiments referring to the drawings.

FIG. 1 is a perspective view of a water-cleaner according to the first embodiment of the present invention.

FIG. 2 is an exploded view of the water-cleaner shown in FIG. 1.

FIG. 3 is a cross-sectional view of the water-cleaner taken along a line 3-3 in FIG. 1.

FIG. 4 is a rear view of the water-cleaner shown in FIG. 1.

FIG. 5 is a block diagram of the water-cleaner shown in FIG. 1.

FIG. 6 is a cross-sectional view of the water-cleaner in another position than shown in FIG. 3.

FIG. 7 is a rear view of the water-cleaner in another position than shown in FIG. 4.

FIG. 8 is a block diagram of the water-cleaner in another position than shown in FIG. 5.

FIG. 9 is a perspective view of a water-cleaner according to the second embodiment of the present invention.

FIG. 10 is a block diagram of the water-cleaner shown in FIG. 9.

FIG. 11 is a perspective view of a water-cleaner according to the third embodiment of the present invention.

FIG. 12 is a cross-sectional view of the water-cleaner of FIG. 11 switched to a filtering mode.

FIG. 13 is a cross-sectional view of the water-cleaner of FIG. 11 switched to a spraying mode.

FIG. 14 is a perspective view of a car and the water-cleaner of FIG. 13 electrically connected to the car.

FIG. 15 is a perspective view of the water-cleaner shown in FIG. 13.

### DETAILED DESCRIPTION OF EMBODIMENTS

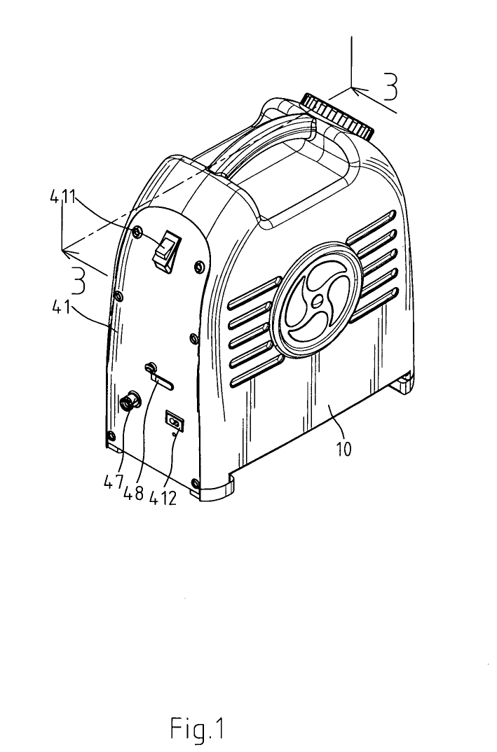

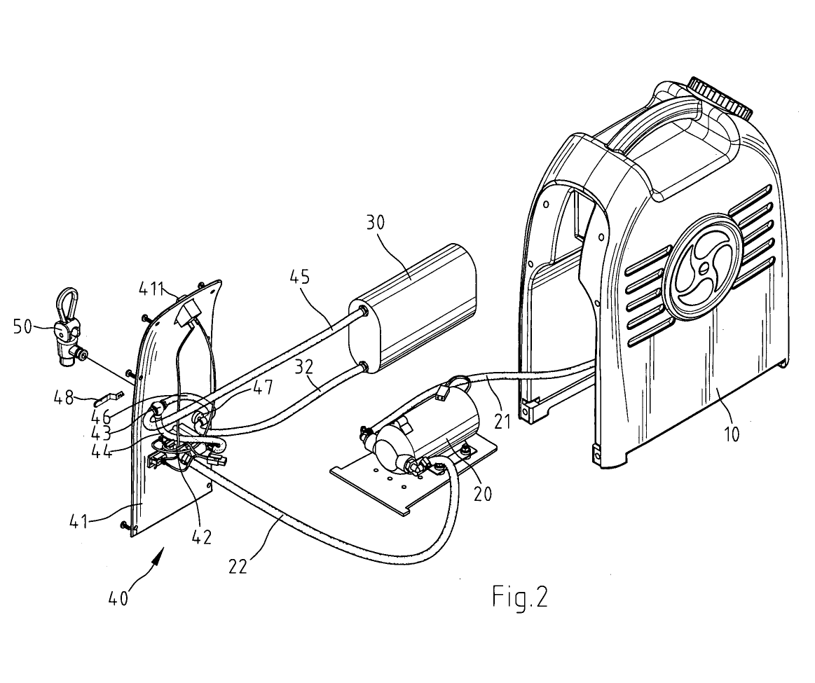

Referring to FIGS. 1 through 3, there is shown a portable direct-current (“DC”) water-cleaner according to a first embodiment of the present invention is shown. The portable DC water-cleaner includes a tank 10, a pump 20, a filter 30 and a mode-switching device 40.

The tank 10 includes a water chamber 11 for containing a lot of water and a component chamber for containing the pump 20, the filter 30 and the mode-switching device 40.

A pipe 21 is lead from the water chamber 11 into the component chamber and, more specifically, to the pump 20. There is a pipe 22 lead from the pump 20 to the mode-switching device 40.

The mode-switching device 40 includes a panel 41 installed on the tank 10. There is a regulator 42 installed on the panel 41. The pipe 22 is lead to the regulator 42. A valve 43 is connected to the regulator 42 through a pipe 44, to the filter 30 through a pipe 45 and to an outlet element 47 through a pipe 46. The outlet element 47 is installed on the panel 41. The valve 43 includes a handle 48 operable for switching the valve 43 between a first mode and a second mode. In the first mode, the water is transmitted to the filter 30 through the pipe 45 so that the water can be directed to the outlet element 47 through a pipe 32. In the second mode, the water is directly transmitted to the outlet element 47, with the filter 30 bypassed. There is a switch 411 electrically connected to the pump 20. The switch 411 is installed on the panel 41. The switch 411 is operable for turning on and off the pump 20.

There is a provided a faucet or tap 50. The faucet 50 can be connected to the outlet element 47 so that the water can be flown from the faucet 50.

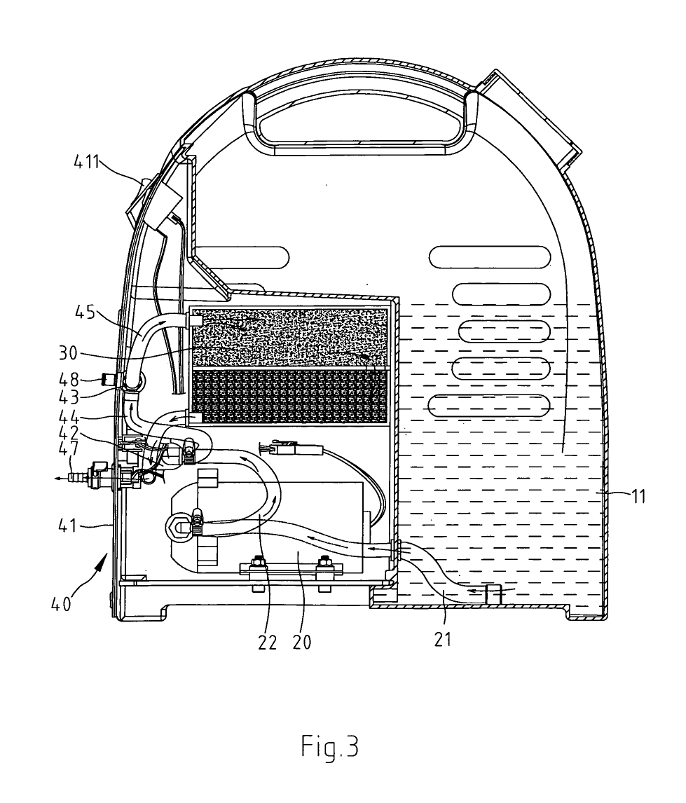

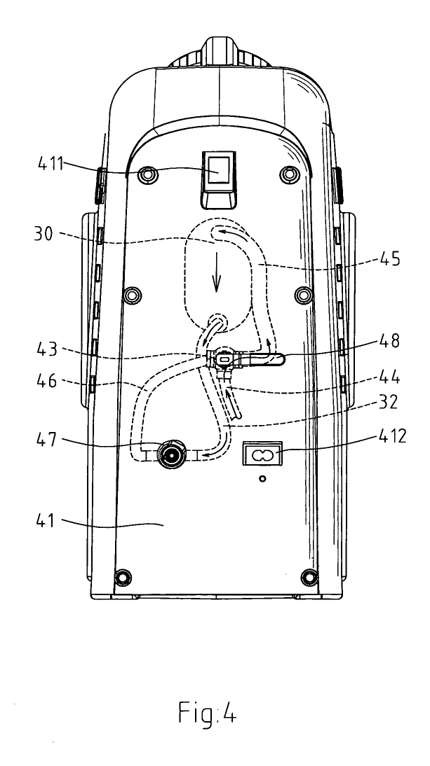

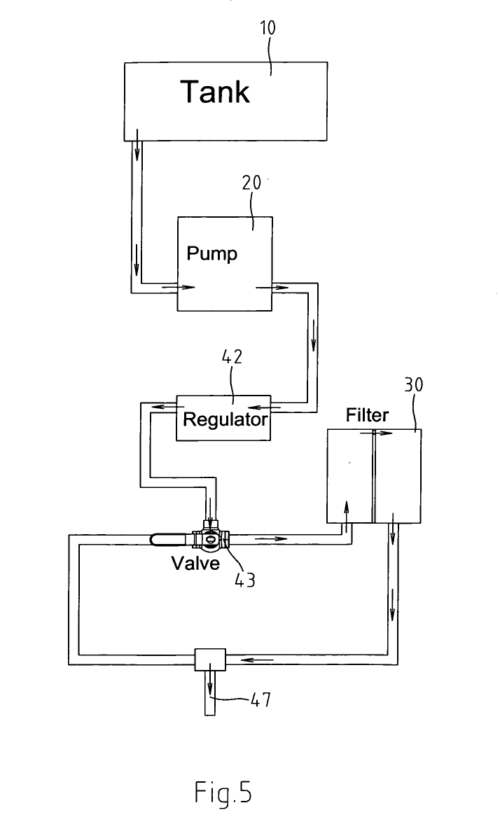

Referring to FIGS. 3 through 5, there is shown a mode in which the water is cleaned before it is flown from the outlet element 47. Water is contained in the water chamber 11 of the tank 10. The switch 411 is operated to turn on the pump 20 to pump the water to the filter 30. The hydraulic pressure of the water is regulated by the regulator 42. The handle 48 is operated to switch the valve 43 to the first mode as shown in FIG. 4. Because of the pump 20, the water travels through the filter 30 fast and flows from the outlet element 47. The filter 30 may employ a reverse-osmosis technique or include active carbon for clearing the water.

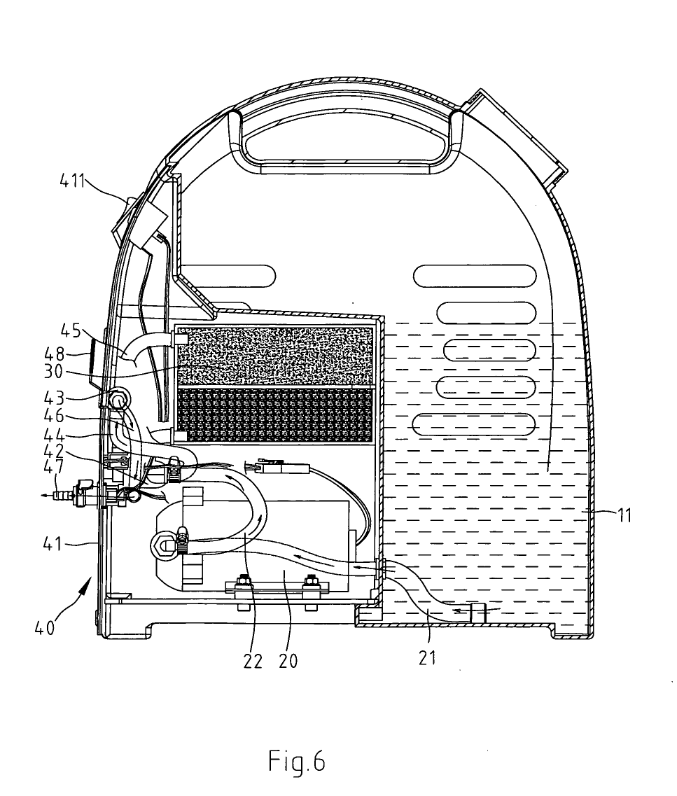

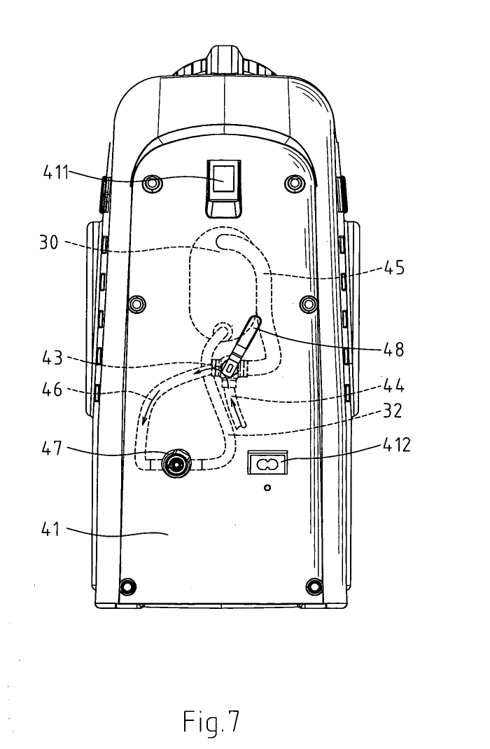

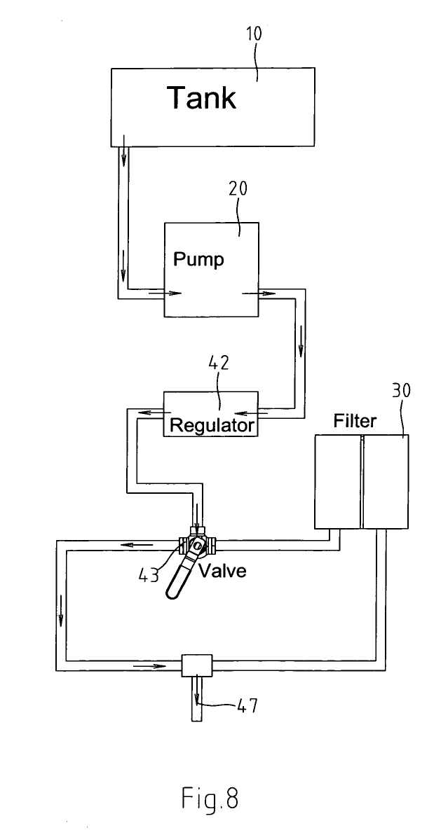

Referring to FIGS. 6 through 8, there is shown a mode in which the water is not cleaned. The handle 48 is operated to switch the valve 43 to the second mode as shown in FIG. 7. The water travels to the outlet element 47 from the valve 43 directly. Then, the water flows from the outlet element 47.

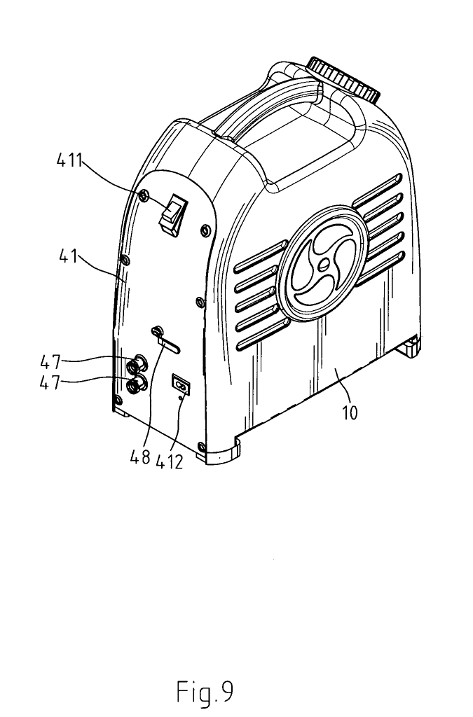

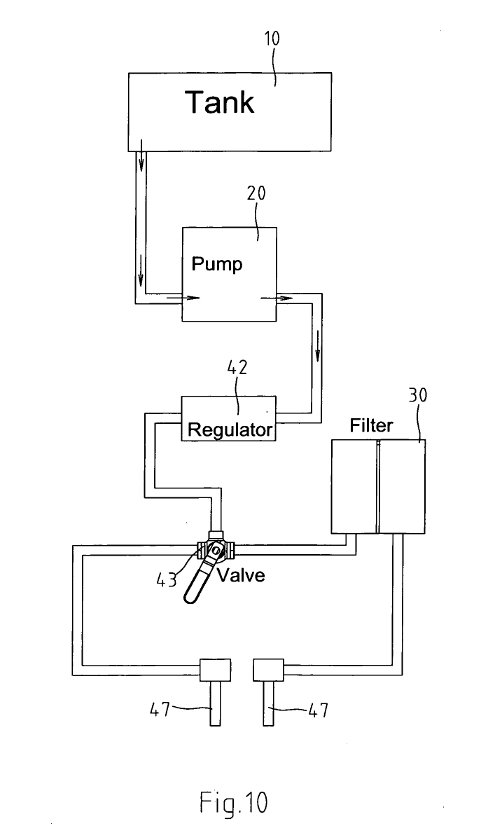

Referring to FIGS. 9 and 10, there is shown a portable DC water-cleaner according to a second embodiment of the present invention. The second embodiment is like the first embodiment except including two outlet elements 47. One of the outlet elements 47 is connected to the filter 30 through the pipe 32 while the remaining outlet element 47 is connected to the valve 43 through the pipe 46.

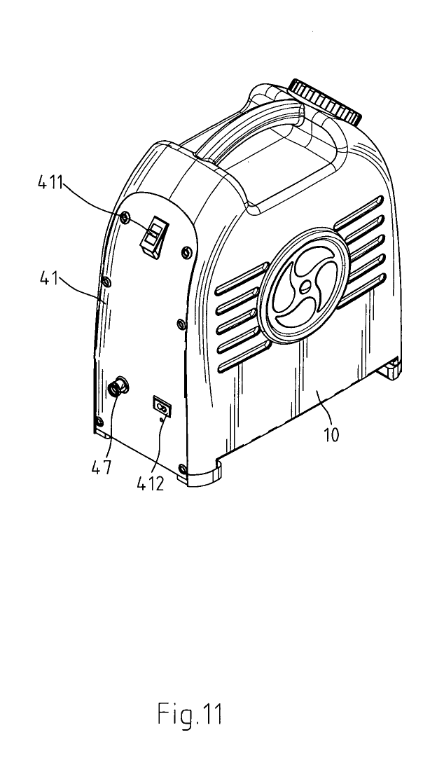

Referring to FIGS. 11 through 15, there is shown a portable DC water-cleaner according to a third embodiment of the present invention. The third embodiment is like the first embodiment except that the pump 20 can be switched between three modes by operating the switch 411. When the pump 20 is in the first mode, the portable DC water-cleaner is in a clearing mode. When the pump is in the second mode, the portable DC water-cleaner is in a spraying mode. When the pump is in the third mode, the portable DC water-cleaner is in an idle mode.

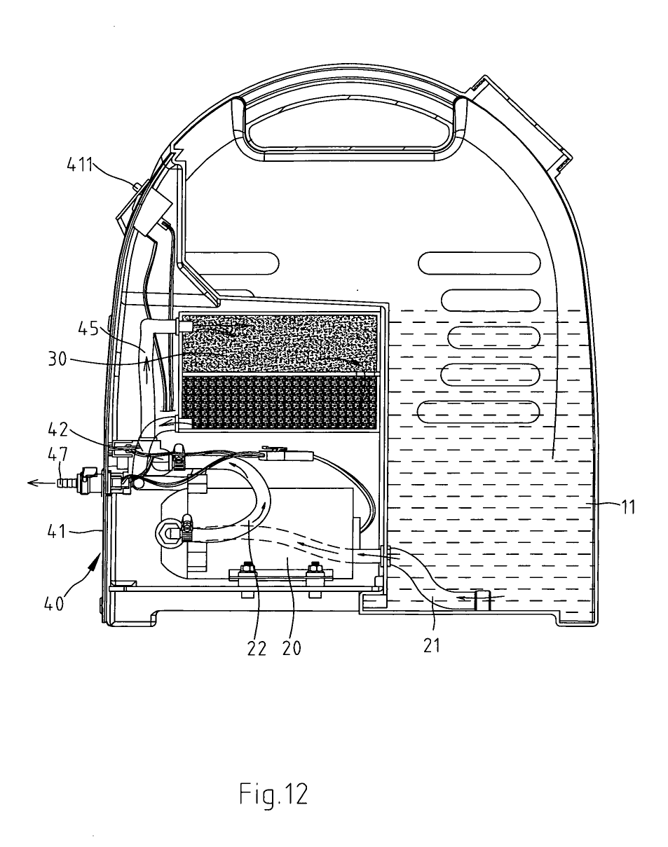

Referring to FIG. 12, the portable DC water-cleaner is in the cleaning mode. The pump 20 pumps the water to the filter 30 from the water chamber 11 of the tank 10. The water flows from the filter 30 through the outlet element 47.

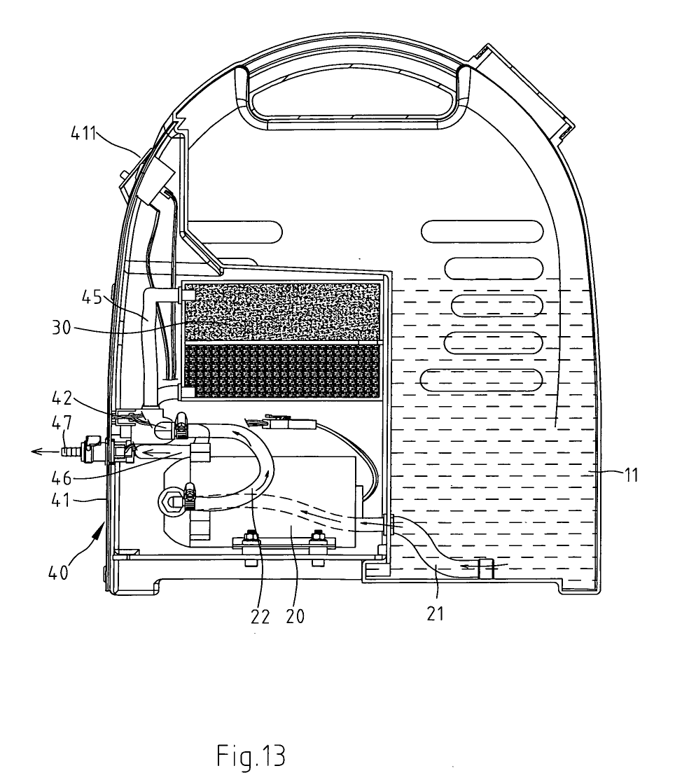

Referring to FIG. 13, the portable DC water-cleaner is in the spraying mode. The pump 20 pumps the water to the outlet element 47 from the water chamber 11 of the tank 10 through the regulator 42. The water flows from the filter 30 through the outlet element 47.

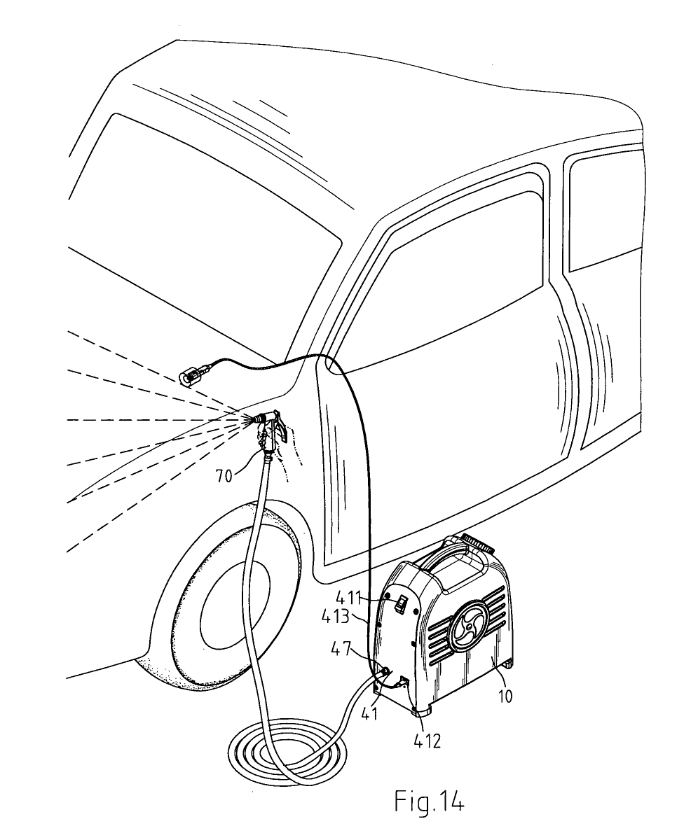

Referring to FIG. 14, there is a socket 412 installed on the panel 41. There is a wire 413 including a first plug at a first end and second plug at a second end. The first plug is inserted in a socket connected to a power supply installed in a car while the second plug is inserted in the socket 412. Electricity is transmitted to the portable DC water-cleaner from the power supply through the wire 413.

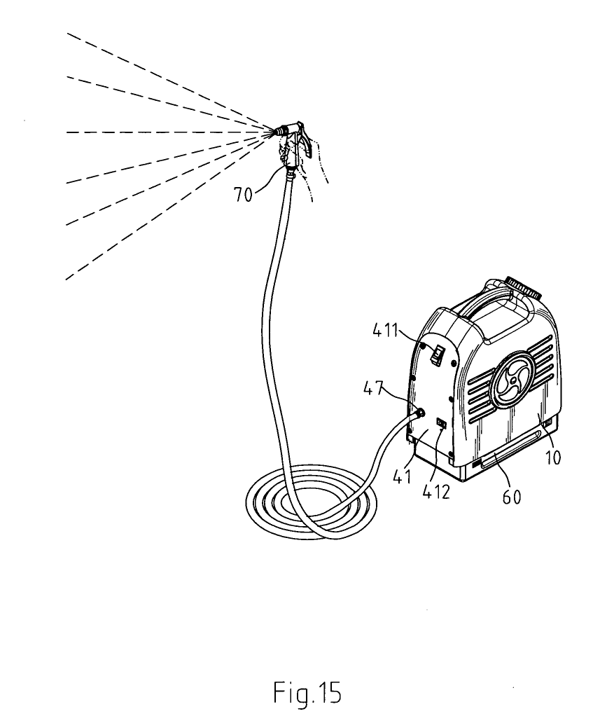

Referring to FIG. 15, there is shown a battery 60 for energizing the portable DC water-cleaner.

There is a nozzle 70 connected to the outlet element 47 through a hose. The water can be sprayed from the nozzle 70.

The portable DC water-cleaner according to the present invention exhibits several advantages. Firstly, it cleans water fast for using the pump 20 to pump the water through the filter 30. Secondly, it provides a stable stream of water for using the regulator 42 to regulating the hydraulic pressure of the water. Thirdly, it provides options of whether to clean the water or not. Fourthly, it provides a 2-in-1 design that incorporating cleaning and spraying modes.

The present invention has been described through the illustration of the embodiments. Those skilled in the art can derive variations from the embodiments without departing from the scope of the present invention. Hence, the embodiments shall not limit the scope of the present invention defined in the claims.

What is claimed is:

1. A portable direct current water-cleaner comprising:
a tank for containing water;
a pump installed in the tank for pumping the water;
a filter installed in the tank for filtering the water; and
a valve installed in the tank and movable between a first mode for directing the water from the pump to the filter so that the pump makes the water travel through the filter fast and a second position for bypassing the filter.

2. The portable direct current water-cleaner according to claim 1 wherein the filter comprises a filtering material.

3. The portable direct current water-cleaner according to claim 2 wherein the filtering material comprises a reverse-osmosis material.

4. The portable direct current water-cleaner according to claim 2 wherein the filtering material comprises active carbon.

5. The portable direct current water-cleaner according to claim 1 wherein the valve comprises a handle operable for switching the valve between the first and second positions.

6. The portable direct current water-cleaner according to claim 1 comprising a battery for energizing the pump.

7. The portable direct current water-cleaner according to claim 1 wherein the pump is energized by a power supply of a vehicle.

8. The portable direct current water-cleaner according to claim 1 wherein the tank comprises a water chamber.

9. The portable direct current water-cleaner according to claim 8 comprising a pipe for connecting the water chamber to the pump.

10. The portable direct current water-cleaner according to claim 1 comprising a regulator arranged between the pump and the valve for regulating the hydraulic pressure of the water.

11. The portable direct current water-cleaner according to claim 10 comprising a pipe for connecting the pump to the regulator.

12. The portable direct current water-cleaner according to claim 10 comprising a pipe for connecting the regulator to the valve.

13. The portable direct current water-cleaner according to claim 1 comprising an outlet element connected to the filter on one hand and connected to the valve on the other hand.

14. The portable direct current water-cleaner according to claim 13 comprising a pipe for connecting the filter to the outlet element.

15. The portable direct current water-cleaner according to claim 13 comprising a pipe for connecting the valve to the outlet element.

16. The portable direct current water-cleaner according to claim 1 comprising a pipe for connecting the valve to the filter.

17. The portable direct current water-cleaner according to claim 1 comprising a first outlet element connected to the filter and a second outlet element connected to the valve.
